(19) United States
(12) Patent Application Publication
(10) Pub. No.: US 2004/0119611 A1
(43) Pub. Date: Jun. 24, 2004

(54) System and method for progressive spatial data service

(76) Inventors: Byoung-Woo Oh, Daejeon (KR); Eunkyu Lee, Daejeon (KR); Mi-Jeong Kim, Daejeon (KR); Minsoo Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/609,613

(22) Filed: Jul. 1, 2003

(30) Foreign Application Priority Data
Dec. 23, 2002 (KR) 10-2002-0082350

(51) Int. Cl. G08G 1/123

(52) U.S. Cl. 340/995.12; 707/1

(57) ABSTRACT

A spatial data service system includes a spatial data output client 10 and a spatial data server 20. The spatial data output client 10 progressively displays on a user's screen spatial data which has been progressively received from the spatial data server 20. Thus, the user can save time required for confirming the spatial data. Further, time consumed for processing a request for additional spatial data, if any, can be reduced. Still further, since transmission of unnecessary data is efficiently avoided, a network load can be lowered, resulting in reduction of additional costs that might be caused due to the network load.

### FIELD OF THE INVENTION

The present invention relates to a system and a method for a progressive spatial data service; and, more particularly, to a system and a method for a progressive spatial data service capable of transmitting spatial data and then displaying the transmitted spatial data on a monitor of a user in a progressive manner, thereby reducing time and costs for acquiring the spatial data.

### BACKGROUND OF THE INVENTION

A map refers to a drawing as a symbolic representation of geographical features or figures at a certain reduced scale. The map serves as a guide to the location of a target object or a target region. In recent years, the advent and development of the Internet have diversified a method for providing geographic information. For example, a user can access the geographic information by using a computer, a wireless communications device, and the like. Such a web geographic information system (hereinafter, referred to as GIS) using the Internet is a web-based system in which a web server provides a map showing geographical features and figures of a target region in case a web client accesses the web server and then selects the target region. In addition to the web-based GIS, a client-server-based GIS has been developed in order to provide the user with geographic/spatial data. In the client-server-based GIS, the user utilizes a certain client program to access a data server and then receives geographic/spatial data therefrom. The client-server-based GIS has an advantage in that it can provide various geographic/spatial data more promptly than the web-based GIS.

Both the client-server-based GIS and the web-based GIS, however, show drawbacks as follows. In both systems, the spatial data requested by the user is not displayed on the user's screen until the whole data is completely downloaded from the data server. Thus, a great amount of time is consumed for the user to acquire a map displayed on the screen, the map corresponding to the spatial data that have been requested for. Further, in case the spatial data received from the data server is not final target data but just intermediate data, i.e., in case the user intends to enlarge or move the initially received spatial data, it is demanded to receive additional spatial data. Both the initially received spatial data and the additional spatial data should be received continuously all through respective spatial data, which results in increase of time required for obtaining the final target data. However, that is a waste of time since the initially received spatial data merely serve as a medium for obtaining the final target data. Furthermore, since communication cost is imposed depending on the amount of transmitted data in a wireless communications network, it is inevitable to pay for all the initially received spatial data, which is a waste of costs. If the amount of data to be transmitted is increased because of the additional spatial data added thereto, the time and costs will be greatly increased as well. In particular, if the user utilizes a cellular phone or a personal digital assistant (PDA), the problem of transmission delay may become more serious because communication and data processing efficiency of the terminal is lower than that of a wired communications network. As a result, the user, who is familiar with a high-speed data transmission service of the wired communications network, may be divested of interest on the GIS service itself. In that case, it is probable that the GIS may be ignored by users and development thereof is hampered.

### SUMMARY OF THE INVENTION

It is, therefore, an object of the present invention to provide a system and a method for a progressive spatial data service capable of transmitting spatial data and displaying the transmitted spatial data on a monitor of a user in a progressive manner and, further, capable of canceling the spatial data currently being transmitted and then requesting a transmission of a new spatial data in case the user requests the new spatial data in the middle of receiving the spatial data currently being transmitted.

In accordance with one aspect of the present invention, there is provided a spatial data service system including: a spatial data output client for making a request for spatial data to receive the spatial data and then outputting the received spatial data on a screen; and a spatial data server for transmitting the spatial data to the spatial data output client in response to the request of the spatial data output client, wherein the spatial data server transmits the requested spatial data to the spatial data output client in a progressive manner.

In accordance with another aspect of the present invention, there is provided a spatial data service method, employed in the spatial data service system, including the steps of: (a) sending the request for progressive transmission of the spatial data to the spatial data server by the spatial data output client; (b) analyzing the request by the spatial data server; (c) retrieving the requested spatial data by the spatial data server; (d) extracting the spatial data to be progressively transmitted to the spatial data output client by the spatial data server; (e) sending the extracted spatial data to the spatial data output client in the progressive manner by the spatial data server; (f) displaying the spatial data progressively received from the spatial data server on a user's screen at predetermined time intervals by the spatial data output client; and (g) repeating the steps (a) to (f) when a user's new request for spatial data is accepted by the spatial data output client.

### BRIEF DESCRIPTION OF THE DRAWINGS

The above and other objects and features of the invention will become apparent from the following description of preferred embodiments given in conjunction with the accompanying drawings, in which:

FIG. 1 is a block diagram of a system for a progressive spatial data service in accordance with a preferred embodiment of the present invention;

FIG. 2 provides a flowchart describing a method for the progressive spatial data service in accordance with a preferred embodiment of the present invention; and

FIG. 3 exemplifies outputs of a spatial data output client shown in FIG. 1.

### DETAILED DESCRIPTION OF PREFERRED EMBODIMENTS

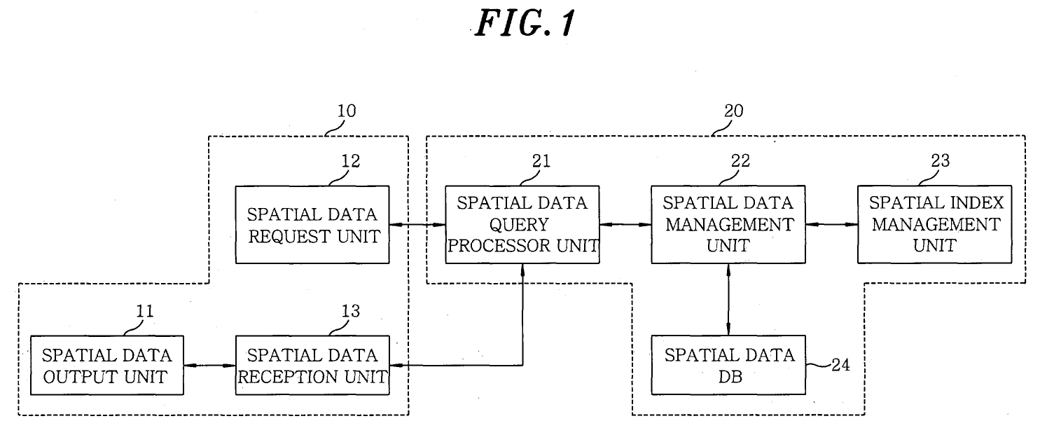

Referring to FIG. 1, there is illustrated a block diagram of a system for a progressive spatial data service in accordance with the present invention.

The system includes a spatial data output client 10 for making a request for spatial data and then displaying the received spatial data on a screen and a spatial data server 20 for providing the spatial data output client 10 with the spatial data corresponding to the request thereof. The spatial data output client 10 has a spatial data output unit 11, a spatial data request unit 12 and a spatial data reception unit 13. The spatial data output unit 11 progressively displays the spatial data received until the current time on the screen in a predetermined time interval. The spatial data request unit 12 periodically makes a request for the spatial data to the spatial data server 20 until all the spatial data is completely received therefrom. The spatial data reception unit 13 receives the spatial data from the spatial data server 20, converts the received spatial data into an internal storage format of the spatial data output client 10 and then sends the converted spatial data to the spatial data output unit 11. The spatial data server 20 includes a spatial data query processor unit 21, a spatial index management unit 23, a spatial data DB 24, and a spatial data management unit 22. The spatial data query processor unit 21 analyzes a request for retrieval of the spatial data from the spatial data output client 10, converts the retrieved spatial data into a transmission format, and then provides the converted spatial data to the spatial data output client 10. The spatial index management unit 23 serves to search for the requested spatial data. And a variety of spatial data are stored at the spatial data DB 24. After the spatial data are retrieved in response to the request for retrieval from the spatial data query processor unit 21 by the spatial index management unit 23, the spatial data management unit 22 extracts the spatial data from the spatial data DB 24. Then, the spatial data management unit 22 progressively provides the extracted spatial data to the spatial data query processor unit 21.

The spatial data request unit 12 within the spatial data output client 10 makes a request for the spatial data to the spatial data query processor unit 21 within the spatial data server 20. At the time of making the request, the spatial data request unit 12 transmits a query sentence to the spatial data query processor unit 21. For the progressive transmission of the spatial data, the query sentence contains sequence information designating the order of the current request among all requests involved as well as general information such as a name of a set including the spatial data set and a desired region. The query sentence for the progressive transmission of the spatial data can be stored and embodied by using a cookie.

The spatial data processor unit 21 analyzes the query sentence and requests the spatial data requested by the user to the spatial data management unit 22. Then, the spatial data query processor unit 21 converts the spatial data, which has been retrieved from the spatial data DB 24 and then transmitted to the spatial data query processor unit 21 via the spatial data management unit 22, into a transmission format and then provides the converted spatial data to the spatial data output client 10. At this time, the retrieved spatial data can be condensed and encoded if the user wants.

The spatial data management unit 22 transfers analysis result of the query sentence, the analysis result being received from the spatial data query processor unit 21, to the spatial index management unit 23 to acquire a spatial data list that satisfies the analysis result of the query sentence. Then, the spatial data management unit 22 accesses the variety of spatial data stored at the spatial data DB 24 and then obtains the spatial data requested by the user based on the spatial data list. Thereafter, the spatial data management unit 22 sends some of the obtained spatial data, i.e., the data portion to be subjected to progressive transmission, to the spatial data query processor unit 21.

The order of dots constituting each of the spatial data should be changed for the progressive transmission of the spatial data. That is, a first dot and a last dot are firstly determined and, then, a dot corresponding to an average value of the two dots is repeatedly calculated. By employing this mechanism, the order of the dots constituting each of the spatial data can be changed. For example, assume that spatial data A is a line data composed of five dots \mathring{1}\mathring{2}\mathring{3}\mathring{4}\mathring{5}. First, a first and a last dot \mathring{1}\mathring{5} are outputted as a first intermediate result and then a dot \mathring{3} is added thereto by a calculation formula of (1+5)/2=3, outputting a second intermediate result \mathring{1}\mathring{5}\mathring{3}. Repetitively, a third intermediate result \mathring{1}\mathring{5}\mathring{3}\mathring{2} and a final result \mathring{1}\mathring{5}\mathring{3}\mathring{2}\mathring{4} of the dot rearrangement are outputted by formulas of (1+3)/2=2 and (3+5)/2=4, respectively. As seen, by these calculations and rearrangements of dots, the order of the dots is changed from \mathring{1}\mathring{2}\mathring{3}\mathring{4}\mathring{5} to \mathring{1}5\mathring{3}\mathring{2}\mathring{4}. Since the spatial data request unit 12 specifies the order of the current request among all the requests at a time when it sends the query sentence to the spatial data server 20, the data management unit 22 progressively transmits only spots according with the current request with the order of the dots having been changed. In the above example, in case the spatial data A composed of the five dots \mathring{1}\mathring{2}\mathring{3}\mathring{4}\mathring{5} is divided into two groups and transmitted over two different instances, the dots \mathring{1}\mathring{5}\mathring{3} are transmitted in response to a first request and the dots \mathring{2}\mathring{4} are sent at a second request. The above-mentioned process, i.e., data rearrangement and progressive transmission, is performed for all of spatial data sets that are to transmitted and only the dots of each of the spatial data sets, which correspond to an order of the current request, are transmitted without being overlapped with already sent dots. For instance, assume that a spatial data result set S is composed of three spatial data sets O1, O2 and O3 (S={O1, O2, O3}) and divided into four groups and transmitted progressively over four instances. A firstly transmitted spatial data set is S1={O1-1, O2-1, O3-1}. Herein, the spatial data O1-1 represents a cluster of dots corresponding to first 0 to 25% of the dots of the spatial data O1 whose order has been changed through the above-mentioned data rearrangement process. Herein, “0 to 25% of the dots” indicates ¼ portion of the dots which are firstly transmitted. Thereafter, the secondly, the thirdly and the fourthly transmitted data sets S2={O1-2, O2-2, O3-2}, S3={O1-3, O2-3, O3-3} and S4={O1-4, O2-4, O3-4}, which correspond to 25 to 50%, 50 to 75% and 75 to 100%, respectively, of the entire data result set S, are transmitted successively. Since there is no overlapped dot between the spatial data O1-1, O1-2, O1-3 and O1-4, the total amount of data transmission, in case the whole data is transmitted over four instances, is found to be equal to that of the case of transmitting the whole data at one time. Further, the method for the progressive spatial data transmission enables the whole map to be displayed even after the transmission of only the firstly transmitted spatial data set S1 is completed, though the details of the map is not shown.

The spatial data DB 24 stores the variety of spatial data to be provided, which are in the form of vector. Before stored at the spatial data DB 24, the variety of spatial data are subjected to the above-mentioned data rearrangement process, i.e., the order of dots in each of the spatial data has been already changed, in order to allow the spatial data management unit. 22 to easily access only the dots of each of the spatial data sets that correspond to an order of the current request.

The spatial index management unit 23 retrieves and selects the spatial data satisfying the query sentence and then sends the spatial data list to the spatial data management unit 22. Spatial indexes herein used are multi-dimensional indexes including a length and an area of the spatial data, an area or a circumference of a MBR (minimum bounding rectangle) as well as two-dimensional or three-dimensional spatial coordinate values. Thus, by using the spatial indexes, it is possible to promptly access spatial data of a desired region in the order of size of the spatial data of the desired region. Further, by using the spatial indexes, unnecessary spatial data with small size, though it satisfies the query sentence, is excluded from the spatial data list. Accordingly, unnecessary data transmission can be avoided and, thus, time and costs required for the data transmission can be saved.

The spatial data reception unit 13 receives the spatial data from the spatial data query unit 21. Then, the spatial data reception unit 13 converts the received spatial data into the internal storage format for the output thereof. The converted spatial data is transferred to the spatial data output unit 11. At this time, if the converted spatial data is compressed or encoded, a process for decompressing or decoding the converted spatial data is conducted. For the progressive transmission of the spatial data, communications with the spatial data server 20 should be maintained until the whole spatial data requested is completely received.

The spatial data output unit 11 displays, on the user's screen, the spatial data progressively obtained from the spatial data reception unit 13 at predetermined time intervals until the whole spatial data requested is received.

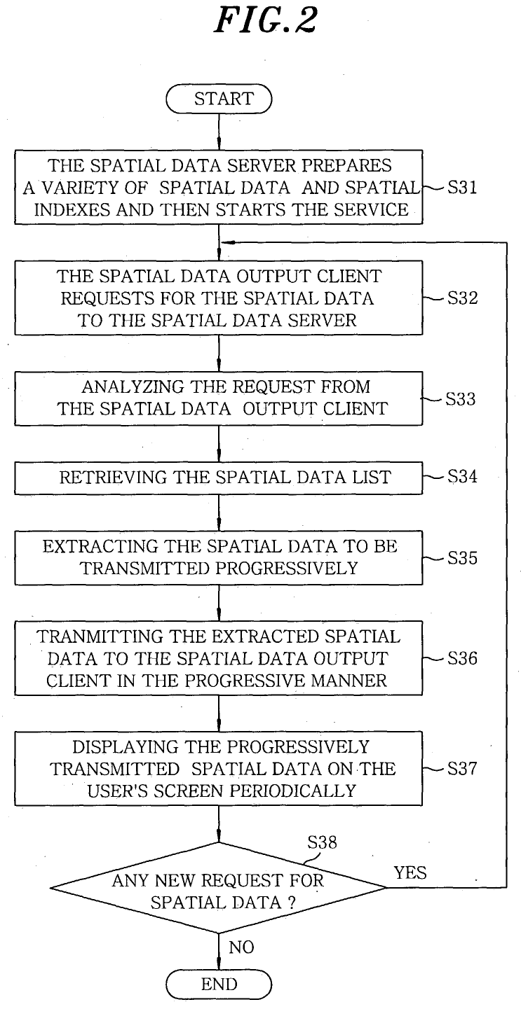

Referring to FIG. 2, there is illustrated a flowchart describing a method for the progressive spatial data service in accordance with the present invention.

First, the spatial data server 20 prepares a variety of spatial data and spatial indexes, and then starts the service (Step 31).

The spatial data output client 10 requests for the spatial data of a target region to the spatial data server 20 (Step 32). The user can designate the target region by, for example, clicking a mouse on a map, inputting a name of a geographical feature or automatically inputting a current position by using a GPS (global positioning system). In the Step 32, the spatial data request unit 12 generates a query sentence for the target region and sends the query sentence to the spatial data query processor unit 21.

The spatial data query processor unit 21 analyzes the query sentence and then provides the analysis result to the spatial data management unit 22 (Step 33).

The spatial data management unit 22 transfers the analysis result received from the spatial data query processor unit 21 to the spatial index management unit 23, which then operates to retrieve and select the spatial data satisfying the analysis result and send a spatial data list to the spatial data management unit 22 (Step 34).

The spatial data management unit 22 accesses the spatial data DB 24 to obtain the spatial data based on the spatial data list. Thus, the obtained spatial data is sent to the spatial data query processor unit 21 (Step 35).

The spatial data query processor unit 21 progressively transmits the spatial data obtained at the step 35 to the spatial data reception unit 13 within the spatial data output client 10, and then the spatial data reception unit 13 sends the progressively received spatial data to the spatial data output unit 11 (Step 36).

The spatial data output unit 11 progressively displays the spatial data on the user's screen (Step 37).

If the user makes a new request for another new spatial data while or after the spatial data are outputted, the steps from 32 to 37 are repeated (Step 38).

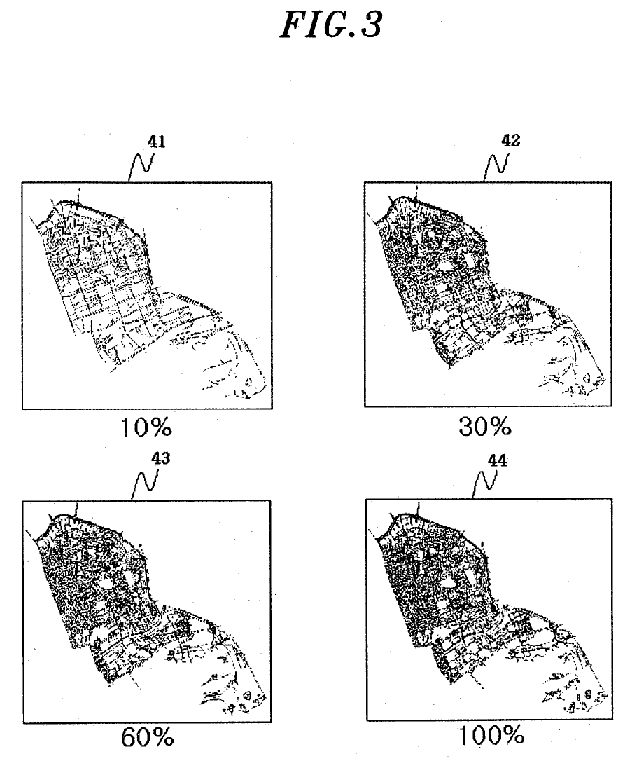

Referring to FIG. 3, there are illustrated output examples of the spatial data output client 10 shown in FIG. 1. As the spatial data are progressively received, a more detailed map is outputted.

First, the spatial data output client 10 requests the spatial data server 20 to progressively send spatial data of, e.g., roads in Gangnam-Gu, Seoul. The spatial data server 20 searches for the requested spatial data to obtain it and progressively transmits the obtained spatial data to the spatial data output client 10. Then, the spatial data output client 10 progressively outputs the spatial data corresponding to the road of Gangnam-Gu, Seoul received from the spatial data server 20. FIG. 3 illustrates maps 41, 42, 43 and 44 respectively showing 10%, 30%, 60% and 100% of the whole road data of Gangnam Gu, Seoul.

As described above, the spatial data output client 10 progressively displays on the user's screen the spatial data which is progressively received from the spatial data server 20. Thus, the user can save time required for confirming the spatial data. Further, time consumed for retrieving additional spatial data, if any, can be reduced. Still further, since the transmission of unnecessary spatial data is efficiently avoided, a network load can be lowered, resulting in reduction of additional costs that might be caused due to the network load.

While the invention has been shown and described with respect to the preferred embodiments, it will be understood by those skilled in the art that various changes and modifications may be made without departing from the spirit and scope of the invention as defined in the following claims.

What is claimed is:

1. A spatial data service system comprising:
a spatial data output client for making a request for spatial data to receive the spatial data and then outputting the received spatial data on a screen; and
a spatial data server for transmitting the spatial data to the spatial data output client in response to the request of the spatial data output client,
wherein the spatial data server transmits the requested spatial data to the spatial data output client in a progressive manner.

2. The system of claim 1, wherein the spatial data output client includes:
a spatial data output unit for progressively displaying a portion of the spatial data received up to the current time on the screen at predetermined time intervals;
a spatial data request unit for periodically sending the request for the spatial data to the spatial data server until the whole spatial data is received; and
a spatial data reception unit for receiving the spatial data provided from the spatial data server, converting the received spatial data into an internal storage format and then providing the converted spatial data to the spatial data output unit.

3. The system of claim 2, wherein the spatial data request unit provides a query sentence containing a name of a set including the spatial data, a desired region and sequence information designating the order of the current request among all requests involved to the spatial data server at the time when the spatial data request unit requests for the spatial data to the spatial data server.

4. The system of claim 1, wherein the spatial data server includes:
a spatial data query processor unit for analyzing the query sentence, receiving retrieved spatial data, converting the retrieved spatial data into a transmission format and delivering the converted spatial data to the spatial data output client;
a spatial index management unit for retrieving and selecting the spatial data satisfying the query sentence;
a spatial data DB for storing a variety of spatial data; and
a spatial data management unit for extracting the spatial data, which are retrieved and selected in the spatial index management unit, from the spatial data DB, and then progressively providing the spatial data to the spatial data query processor unit.

5. The system of claim 4, wherein the spatial data management unit rearranges the order of dots constituting the spatial data and then progressively provides the rearranged spatial data to the spatial data query processor unit.

6. The system of claim 5, wherein the order of the dots constituting the spatial data is rearranged by way of firstly locating a first dot and a last dot and repeatedly calculating a dot corresponding to an average value of the two dots.

7. The system of claim 4, wherein the spatial index management unit retrieves and selects the spatial data and then provides a spatial data list to the spatial data management unit by using multi-dimensional indexes and wherein the spatial data management unit extracts the spatial data from the spatial data DB based on the spatial data list.

8. The system of claim 7, wherein the multi-dimensional indexes has two-dimensional or three-dimensional spatial coordinates values, a length and an area of the spatial data, an area or a circumference of a MBR (minimum bounding rectangle).

9. A spatial data service method, employed in the spatial data service system of claim 1, comprising the steps of:
(a) sending the request for progressive transmission of the spatial data to the spatial data server by the spatial data output client;
(b) analyzing the request by the spatial data server;
(c) retrieving the requested spatial data by the spatial data server;
(d) extracting the spatial data to be progressively transmitted to the spatial data output client by the spatial data server;
(e) sending the extracted spatial data to the spatial data output client in the progressive manner by the spatial data server;
(f) displaying the spatial data progressively received from the spatial data server on a user's screen at predetermined time intervals by the spatial data output client; and
(g) repeating the steps (a) to (f) when a user's new request for spatial data is accepted by the spatial data output client.
